(19) United States
(12) Patent Application Publication
(10) Pub. No.: US 2015/0230020 A1
(43) Pub. Date: Aug. 13, 2015

(54) HEADSET

(71) Applicants: Kee Sook JEON, Nashua, NH (US); Daniel Patrick O'SULLIVAN, Mont Vernon, NH (US); Christopher James AISTON, Mont Vernon, NH (US); Brendan Patrick COLLINS, Manchester, NH (US); Adam JACOBS, Hollis, NH (US); John SHAMBROOM, Framingham, MA (US); Brad GOVERMAN, Sharon, MA (US); Eric GORDON, Boston, MA (US)

(72) Inventors: Kee Sook JEON, Nashua, NH (US); Daniel Patrick O'SULLIVAN, Mont Vernon, NH (US); Christopher James AISTON, Mont Vernon, NH (US); Brendan Patrick COLLINS, Manchester, NH (US); Adam JACOBS, Hollis, NH (US); John SHAMBROOM, Framingham, MA (US); Brad GOVERMAN, Sharon, MA (US); Eric GORDON, Boston, MA (US)

(21) Appl. No.: 14/179,416

(22) Filed: Feb. 12, 2014

(51) Int. Cl. H04R 1/10

(52) U.S. Cl. CPC H04R 1/1091

(57) ABSTRACT

The invention features a headset, and systems including the headset, equipped with electrical sensors. The headset is suitable for use by a child and suitable for use in a gaming system, e.g., to train attention.

### BACKGROUND OF THE INVENTION

The invention features a headset with electrical signal sensors suitable for use by a child and suitable for use in a gaming system, e.g., to train attention.

Electroencephalography (EEG) is the recording of electrical activity along the scalp. It measures voltage fluctuations resulting from the flow of current between neurons of the brain. Commonly, an EEG instrument is a clinical, multichannel device used to measure and display the brain waves of a user. The user's brain waves are monitored by the use of a number of electrodes placed in contact with the scalp in a predetermined pattern, such as the 10-20 system (also known as the international 10-20 system). This placement system is an internationally recognized method for the placement of electrodes on the scalp of a user was developed to ensure standardized reproducibility so that a user's studies could be compared over time, and users could be compared to each other.

EEG measurements can be used to develop a ‘cognitive signature’ that can be used in a “smart” video game that responds to the child's precise cognitive levels of attention or inattention. The child plays the game purely by using their ability to focus without touching a keyboard. Then in real-time, the game personalizes a fantasy world in which the child advances through a number of increasingly difficult tasks using only the child's actual attention levels in order to develop attention and impulsivity control skills. The product then enables the child to transfer those newly learned skills into the real world, where they improve their academic performance and are better able to perform daily activities at home.

An electrode system to capture bioelectric signals, such as electroencephalograph (EEG) signals, from a user generally should address various requirements including safety needs, cost, power consumption, performance, ease of use and user comfort. In a non-clinical application the relative importance of these factors may be somewhat different to that in a clinical application. For example, in a clinical application the electrodes are applied by a relatively skilled technician, whereas in non-clinical application the electrodes are more likely to be applied by a person with no training or knowledge of correct application or placement of the electrodes. Convenience and user comfort are also generally more important in a non-clinical application. A patient in a clinical situation is more likely to be tolerant of some level of discomfort or inconvenience when testing and calibrating electrodes than a person in a non- clinical setting. For example, a conventional clinical apparatus for applying electrodes to a user's head includes a flexible cap that covers the user's entire scalp and includes a strap beneath the chin, so that the cap may be snugly secured to the user's head. This type of apparatus can include over 100 electrodes for some clinical applications.

An electrode system for use by a child should be designed to (i) intuitively and conveniently place electrode sensors at predetermined anatomical positions on the head of the child without significant training, (ii) account for the variability in head size among children of different ages, and (iii) be comfortable to wear.

### SUMMARY OF THE INVENTION

The invention features a headset including two earpieces connected by a head bridge, each of the earpieces connected to an arm having a proximate end connected to one of the two ear pieces and a terminal end including an electrical sensor, wherein each arm is configured to permit the electrical sensor to contact the forehead of a user at positions AF3 or AF4. In particular embodiments, the electrical sensor includes one electrode or two electrodes. The arm can have a shape that includes an arc. In particular embodiments of the headset of the invention, the distance from the center of the ear piece to the center of the electrical sensor is 123±10 mm, 123±6 mm, 123±4 mm, or 123±2 mm. In some embodiments, the electrical sensor includes a fabric electrode. In particular embodiments, one of the two ear pieces includes an electrical sensor positioned to contact the ear lobe of a user. In still other embodiments, one of the two ear pieces includes a ground electrode configured to contact the ear (e.g., contacting the circumference of the outer ear) of a user. For example, the headset can include a first ear piece including an electrical sensor positioned to contact the ear lobe of a user and a second ear piece including a ground electrode The arm can include a flexible member, wherein when the headset is worn by a user, the flexible member is configured to apply light pressure of the electrical sensor to the forehead of the user. In certain embodiments, each arm includes an elastomeric material and/or a spring. In some embodiments, the head bridge includes an elastomeric material. The head bridge of the headset can be adjustable to accommodate various head sizes.

The headset of the invention can be sized and configured to accommodate a range of head sizes from the 5^{th} percentile of 8 year old girls to the 95^{th} percentile of 12 year old boys. The size distribution for this population is found, for example, in Snyder, et al., UM-HSRI-77-17, Anthropometry of infants, children, and youths to age 18 for product safety design, Final Report. Highway Safety Research Institute, The University of Michigan, Ann Arbor, Mich. 48109. May 31, 1977.

In particular embodiments, the headset has an expanded configuration for placement on the head of a user, the expanded configuration having a fixed predetermined angle between the head bridge and each arm. Optionally, the angle between the head bridge and each arm is collapsible to permit the headset to fold from the expanded configuration to a contracted configuration for storage.

The headsets of the invention can also include an accelerometer, a locator, and/or LED lights (e.g., placed around one or more of the ear pieces, each electrical sensor, and/or each arm). The earpieces of the headset can include one or more openings to permit the passage of external sounds to the ear of a user. Optionally, one or both of the earpieces includes a speaker.

The invention also features an electrode system including: (a) a first electrical sensor configured to contact the forehead of a user at position AF3, the first electrical sensor including two or more electrodes, and a second electrical sensor configured to contact the forehead of a user at position AF4, the second electrical sensor including two or more electrodes; and (b) a processor equipped with an algorithm for selecting, independently, at the first electrical sensor and the second electrical sensor from among the two or more electrodes (i) the electrode positioned highest on the forehead of a user capable of making a connection with one of positions AF3 or AF4; (ii) the electrode providing the best signal quality; or (iii) the electrode providing the best contact. The processor for selecting from among the two or more electrodes can be incorporated into the headset (i.e., an on-board processor).

In another aspect, the invention features a system including: (a) a headset including two earpieces connected by a head bridge; each of the earpieces connected to an arm having a proximate end connected to one of the two ear pieces and a terminal end including an electrical sensor, wherein each arm is configured to permit the electrical sensor to contact the forehead of a user at positions AF3 or AF4 and wherein the electrical sensor includes two or more electrodes; and (b) a processor equipped with an algorithm for selecting, independently, at each arm from among the two or more electrodes (i) the electrode positioned highest on the forehead of a user capable of making a connection with one of positions AF3 or AF4; or (ii) the electrode providing the best signal quality. The processor for selecting from among the two or more electrodes can be incorporated into the headset (i.e., an on-board processor).

The invention also features a system including: (i) a headset including two earpieces connected by a head bridge; each of the earpieces connected to an arm having a proximate end connected to one of the two ear pieces and a terminal end including an electrical sensor, wherein each arm is configured to permit the electrical sensor to contact the forehead of a user at positions AF3 or AF4 to collect EEG signals; and (ii) a processor equipped with an algorithm for analyzing the EEG signals to determine the attention level of the user, wherein the headset and the processor are in wireless communication. The processor for analyzing the EEG signals to determine the attention level of the user can be located outside the headset (i.e., an external processor).

As used herein, the term “AF3” refers to the AF3 position in the internationally recognized 10-20 system of placing EEG electrodes on the scalp. AF3 is located intermediate between Fp and F3 on the left side of the user's forehead (see FIG. 13).

As used herein, the term “AF4” refers to the AF4 position in the internationally recognized 10-20 system of placing EEG electrodes on the scalp. AF4 is located intermediate between Fp and F4 on the right side of the user's forehead (see FIG. 13).

As used herein, the term “electrical sensor” refers to a sensor used for measuring bioelectric signals, such as EEG or EMG signals. The electrical sensor can include one or more electrodes, optionally formed from a flexible conductive fabric.

As used herein, the term “head bridge” refers to an adjustable element connecting the two earpieces in the headsets of the invention. The head bridge can be configured to rest atop the head of the user. The head bridge stabilizes the ear pieces resting against the user's ears and stabilizes the electrical sensors resting against the forehead.

As used herein, the term “earpiece” refers to that portion of the headset that fits over the ear of the user and is connected to the head bridge and the arm. The placement of the ear piece over the user's ear positions the electrical sensor for contact with the forehead of a user at positions AF3 or AF4.

Other features and advantages of the invention will be apparent from the following Detailed Description, the drawings, and the claims.

### BRIEF DESCRIPTION OF THE DRAWINGS

FIGS. 1A and 1B are pictures depicting the front view (FIG. 1A) and side view (FIG. 1B) of one embodiment of the headset of the invention.

FIGS. 2A and 2B are pictures depicting the front view (FIG. 2A) and side view (FIG. 2B) of one embodiment of the headset of the invention.

FIGS. 3A and 3B are pictures depicting the front view (FIG. 3A) and angled front view (FIG. 3B) of another embodiment of the headset of the invention. LEDs can be present in the arms and, optionally, the head bridge.

FIGS. 4A and 4B are pictures depicting the front view (FIG. 4A) and side view (FIG. 4B) of another embodiment of headset. LEDs can be present in the earpiece. LEDs can also be placed in the arms.

FIGS. 5A and 5B are pictures depicting the side view (FIG. 5A) and front view (FIG. 5B) of another embodiment of the headset. Earpieces can include front to back slots for sound alone or in addition to LED illumination. LEDs can also be placed in the arms. The head bridge can be comprised of an elastomeric material over spring steel or plastic.

FIGS. 6A and 6B are images depicting the side view (FIG. 6A) and front view (FIG. 6B) of another embodiment of the headset. This diagram depicts earpieces that are thicker at the bottom than at the top creating a more vertical appearance to the headset.

FIGS. 7A and 7B are images depicting the side view (FIG. 7A) and front view (FIG. 7B) of another embodiment of the headset. This embodiment highlights the possibility of a more angular forehead piece and a flat ear cap on the earpiece with spacing for sound. LEDs can be placed under the translucent cap of the forehead piece. The headpiece can be made of elastomeric material over spring steel or plastic.

FIGS. 8A and 8B are images depicting the side view (FIG. 8A) and front view (FIG. 8B) of another embodiment of the headset. This diagram depicts earpieces that are thicker at the top than at the bottom creating a more angular appearance to the headset.

FIGS. 9A and 9B depict the side view (FIG. 9A) and front view (FIG. 9B) of another embodiment of the headset. This embodiment highlights the flexibility of some of the possible design options with cap of the earpieces being swappable by the user. LEDs or colored materials can provide color above the electrical sensors. There can also be color variations in the head bridge and the arms.

FIGS. 10A and 10B depict the side views (FIG. 10A) and front views (FIG. 10B) of several headset embodiments for comparison. FIGS. 10C and 10D depict the side views (FIG. 10C) and front views (FIG. 10D) of these embodiments as worn by a user.

FIG. 11 depicts the side view of an embodiment of the headset. LEDs line the perimeter of the electrical sensors and the inner area of the earpiece between the ear cushion and the head bridge. High gloss molded plastic can be used for the head bridge with black chrome accents around the earpiece and the adjustable section of the head bridge.

FIG. 12 depicts a side view of an embodiment of the headset. This diagram demonstrates the 123 mm distance from the center of the ear piece to the center of the electrical sensor.

FIG. 13 represents depictions of several mannequin heads with the AF3 and AF4 locations marked based on the EEG 10-20 system. The AF3 and AF4 locations represent the target regions for electrical sensor contact with the user's forehead.

FIG. 14 shows depictions of a mannequin head with the estimated locations of the electrical sensors around the AF3 target for a girl in the 5^{th} percentile and a boy in the 95^{th} percentile for size, assuming a 123 mm arm length.

FIG. 15 depicts a side view of an embodiment of the headset. Soft faux leather covers the earpieces with silver cloth electrodes. The flexible arm adjusts to head shape and applies light pressure to the AF3 and AF4 positions of the forehead. The head bridge is also adjustable. The earpiece caps can be customizable with possible matching LED accents surrounding the electrical sensors in the arms.

FIG. 16 depicts drawings of an embodiment of the dual electrical sensor assembly that can be located at the end of the arms of the headset.

FIG. 17 is a depiction of the front view of the arms and earpieces and the side view of the earpieces embodying an ornamental design of the invention.

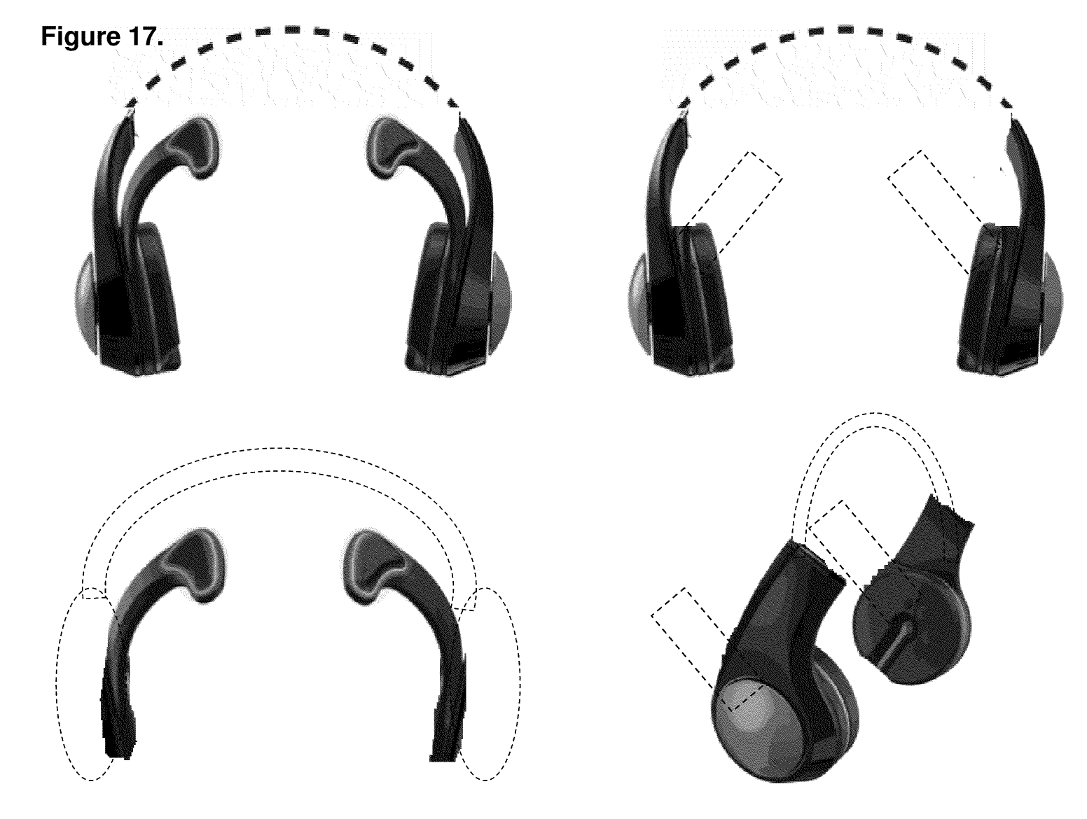

FIG. 18 is a side view of the arms embodying an ornamental design of the invention.

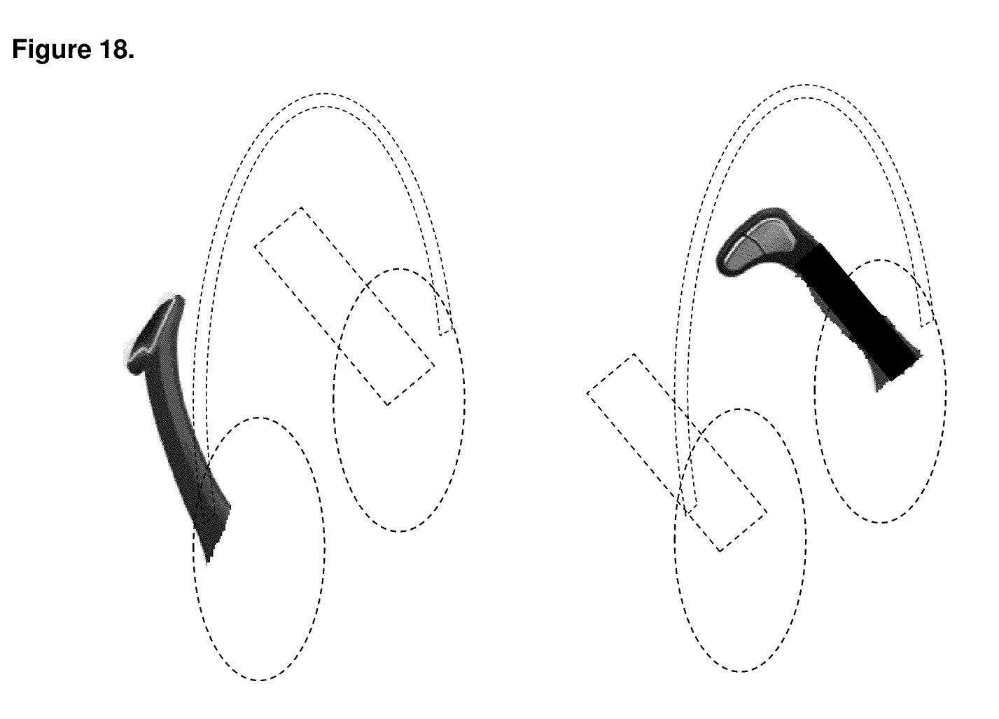

FIG. 19 is a depiction of the angled front view of the arms and earpieces embodying an ornamental design of the invention.

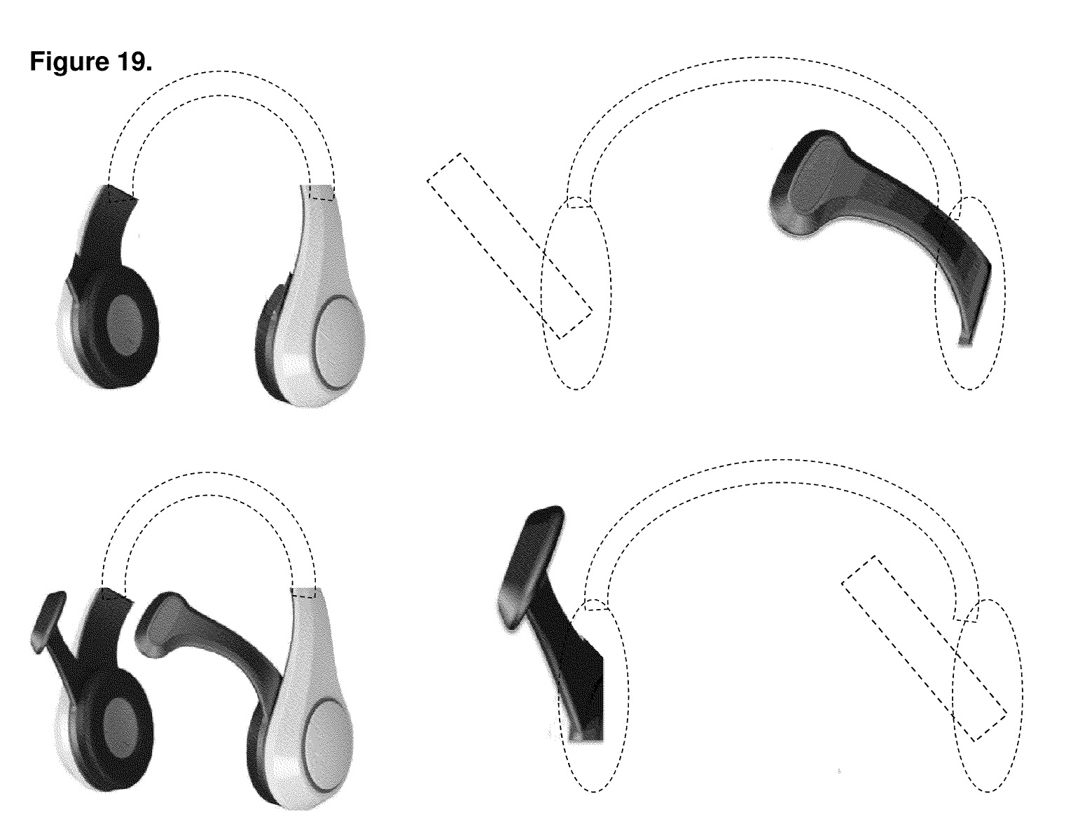

FIG. 20 is an angled back view of the arms and earpieces embodying an ornamental design of the invention.

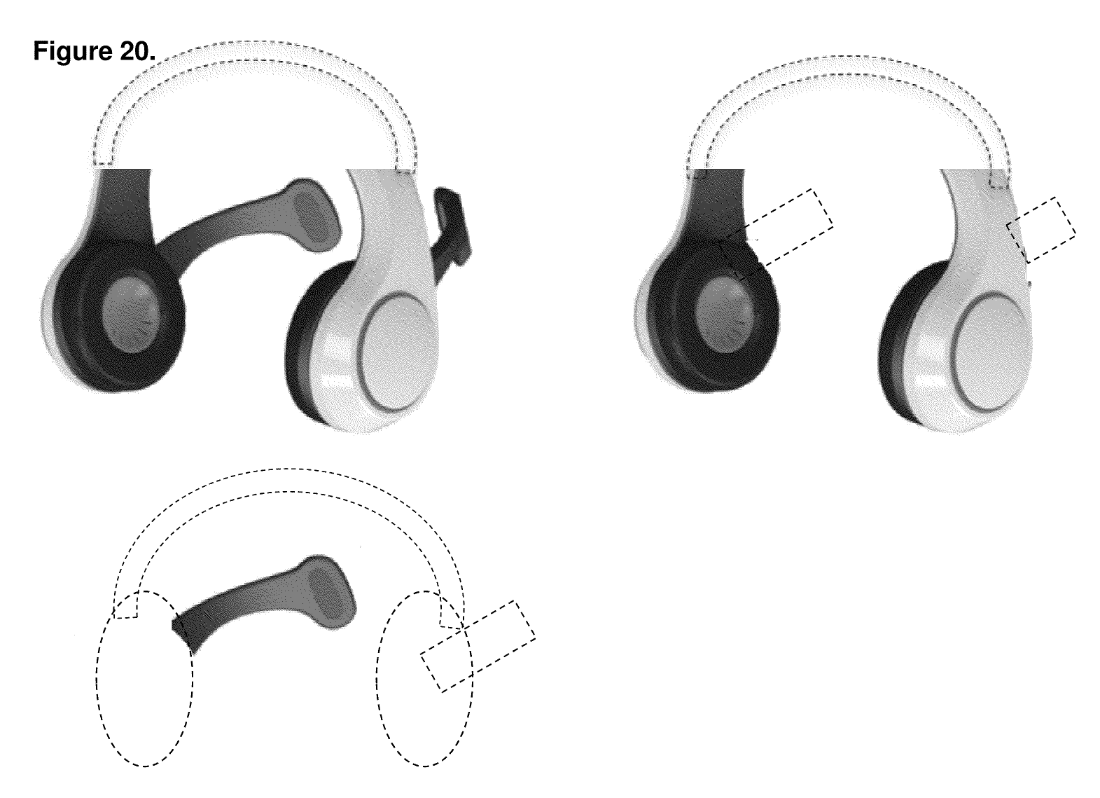

### DETAILED DESCRIPTION

The invention features an electrode system in the form of a headset designed for use by a child. The headsets of the invention are designed to (i) intuitively and conveniently place electrical sensors at positions AF3 and AF4 on the forehead of a child (i.e., without significant training in how to wear the headset), (ii) account for the variability in head size among children of different ages, and (iii) be comfortable to wear. For example, particular embodiments of the headsets of the invention are sized and configured to accommodate a range of head sizes from the 5^{th} percentile of 8 year old girls to the 95^{th} percentile of 12 year old boys. While the headset of the invention is designed for kids ages 8-12, it will also fit most adults as well, since the head size of a 12 year old boy is close to adult sized head.

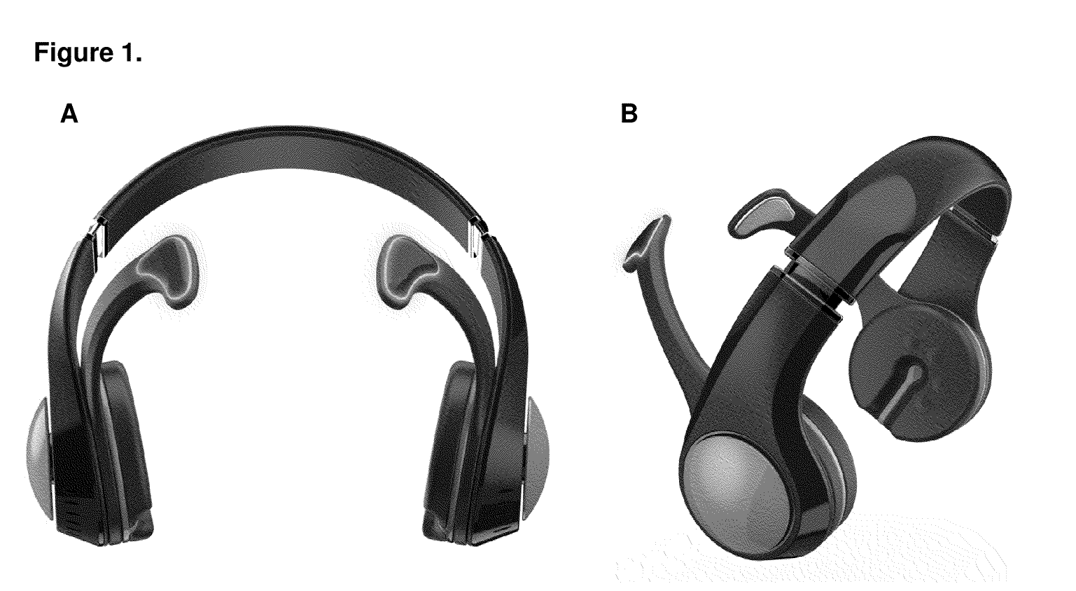

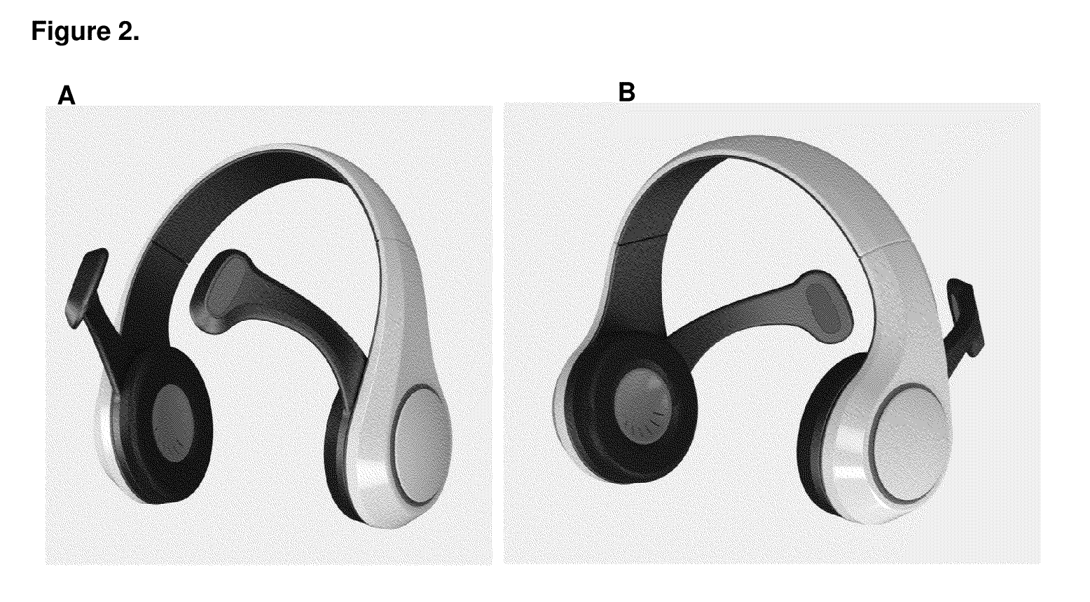

The headsets of the invention contain electrical sensors that measure EEG signals that are processed by an external computer. FIGS. 1-2 depict embodiments of the headset. Both resemble over the ear headsets with arms containing terminal electrical sensors that positioned, in part, by their connection to earpieces fitting over the ears of the user.

The electric sensors can include one or more electrodes for measuring EEG signals of a use. The electrodes can be dry electrodes or wet electrodes (i.e., a dry electrode can obtain a signal without a conductive and typically wet material between the electrode and the user's skin, and a wet material does require such a conductive material). In particular embodiments the electrical sensor includes a dry electrode, such as a dry fabric electrode. Fabric electrodes suitable for use in the headsets of the invention include those described in U.S. Patent Pub. No. 20090112077, incorporated herein by reference.

The electrode systems and headsets of the invention can include electrical sensors having two or more electrodes and configured to contact the forehead of a user at a predetermined position (e.g., AF3 or AF4). Such a system allows for the selection from among the two or more electrodes (i) the electrode positioned highest on the forehead of a user capable of making a connection with one of positions AF3 or AF4; (ii) the electrode providing the best signal quality; or (iii) the electrode providing the best contact. Such a system is tolerant of a misplacement of the electrical sensors by the user. In one scenario the electrical sensor is positioned by the user such that the upper electrode is in the user's hair and the lower electrode is positioned just below the scalp. In this case, the lower electrode would provide the best connection with AF3 or AF4. In another scenario the electrical sensor is positioned by the user such that the upper electrode is high on the user's forehead, but below the hairline, and the lower electrode is positioned just above the eye brow. In this case, the upper electrode would provide the best connection with AF3 or AF4. A variety of techniques may be used for selecting the appropriate electrode in the electrical sensor. For example, before the headset is placed on the user's head the on-board processor can be configured to test the connections of the electrodes to each other. After the headset is placed on the head of the user the processor can again test the connections of the electrodes to each other by measuring the impedance between the connections. The selection from among the two or more electrodes at an electrical sensor can be performed independently for each electrical sensor in the electrode system or headset. If, for a given electrical sensor, a connection between two electrodes within the sensor is observed, then the processor can be programmed to select the upper electrode (i.e., as the lower electrode is predicted to be too low on the user's forehead to provide a connection with AF3 or AF4). If, for a given electrical sensor, no connection between two electrodes within the sensor is observed, then the processor can be programmed to select the lower electrode (i.e., as the upper electrode is predicted to be positioned above the user's hair line and not providing a quality connection with AF3 or AF4). Alternatively the processor can be configured to be continually measuring the electrical impedance through each electrode to the next one. In this approach the electrode with the lowest impedence is preferentially selected to provide the best contact. Optionally, the processor is configured to monitor the signal to noise ratio from each of the two or more electrodes and, for each electrical sensor, select the electrode having the best ratio (i.e., the least noise) to provide the best signal quality.

The headsets of the invention can be incorporated into a system including an external processor, such an analog or digital signal processor, a co-processing device, and associated memory for storing a series of instructions, otherwise known as a computer program or a computer control logic, to cause the processing system to perform desired functional steps. The headset is connected to the external processor via a wireless transmission device or a wired link. The memory includes a series of instructions defining at least one algorithm for detecting and classifying a predetermined type of mental state, such as an attentive or inattentive mental state. Upon detection of a predefined mental state, a corresponding control signal is transmitted to an input/output interface. From the input/output interface, the control sign can be transmitted to a platform for use as a control input by a gaming application, program, simulator, or other application.

The systems of the invention include a headset in communication (i.e., wired or wireless) with an external processor equipped with a computer program capable of, for example, processing the EEG signal to determine the attention state of the user, in a multi-electrode sensor selecting the preferred electrode for signal acquisition, and/or providing feed-back to the user in the form of a game. As part of a game, the system can be configured to operate, for example, as described in U.S. Patent Pub. No. 20120108997, incorporated herein by reference. Methods for processing the EEG signal to determine the attention state of the user are described, for example, in U.S. Patent Pub. No. 20110191350, U.S. Patent Pub. No. 20130331727, and PCT Pub. No. WO2013147707 A1, each of which is incorporated herein by reference.

Specific embodiments of the headsets of the invention are described in more detail below.

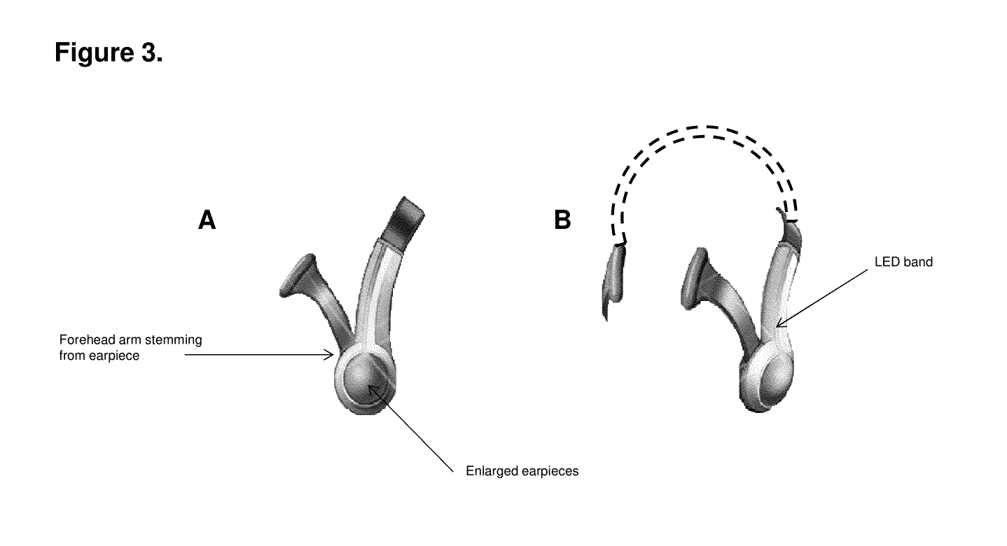

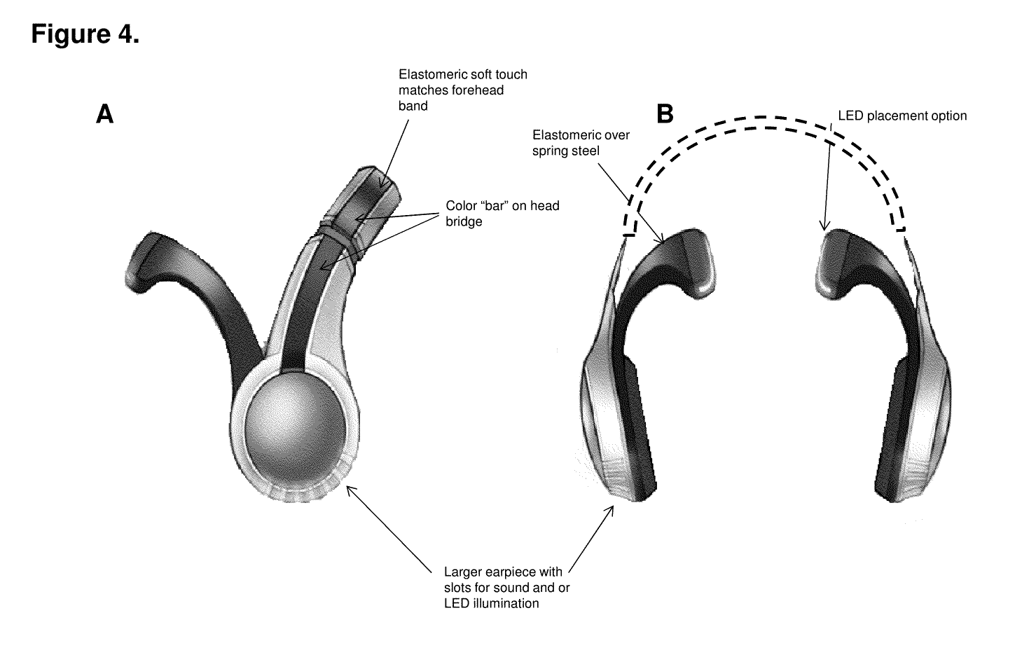

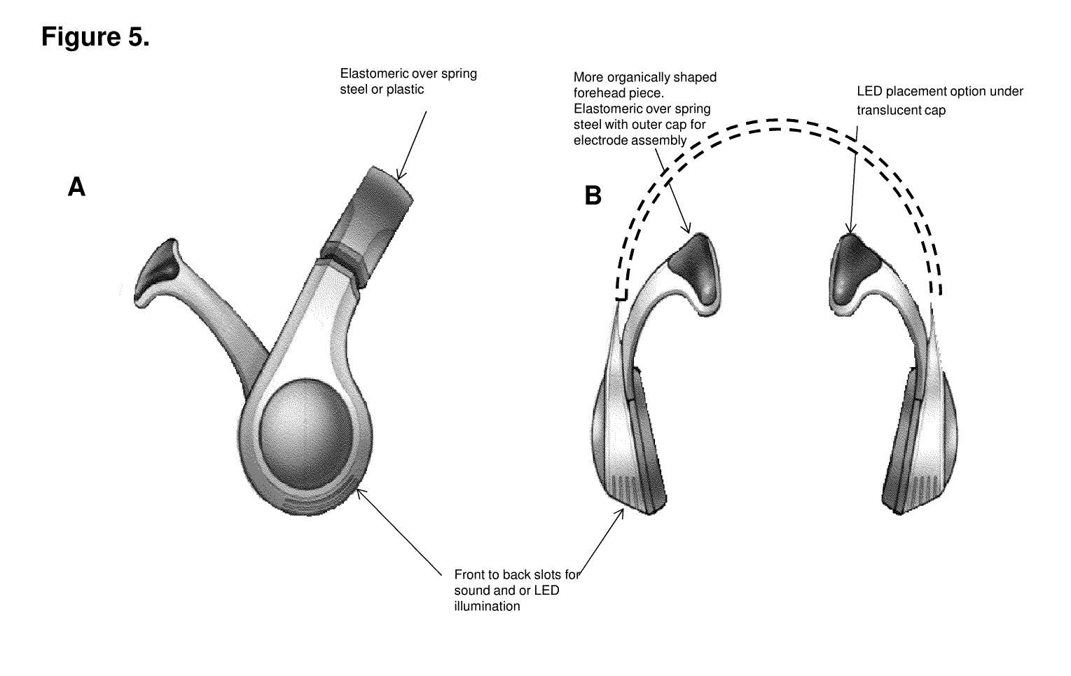

FIGS. 3-10 depict different embodiments of the headset. The embodiments depicted include a head bridge that rests comfortably atop the head of the user, the earpieces cover the ears of the user, and the pivoting arms contact the forehead of the user at positions AF3 and AF4. FIG. 3 depicts a headset with a large LED band on either side of the head bridge in addition to an LED in each of the terminal ends of the arms. FIG. 4 depicts an embodiment with larger earpieces that have slots perpendicular to the ear for LED illumination and/or sound circulation. LEDs can also be placed at the terminal end of each arm. The arms are elastomeric over spring steel with matching elastomeric soft touch material on the head bridge. The head bridge can also have a colored portion. FIG. 5 depicts another embodiment. The earpieces have front to back slots for sound circulation and/or LED illumination. The terminal end to the arm is more rounded in shape and is elastomeric over spring steel.

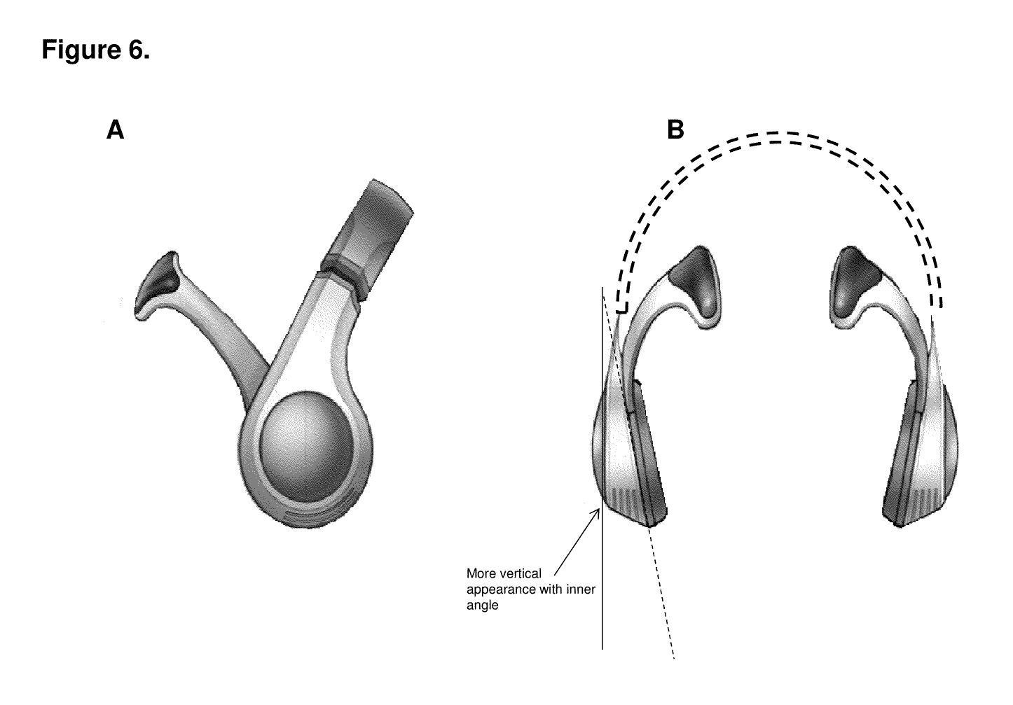

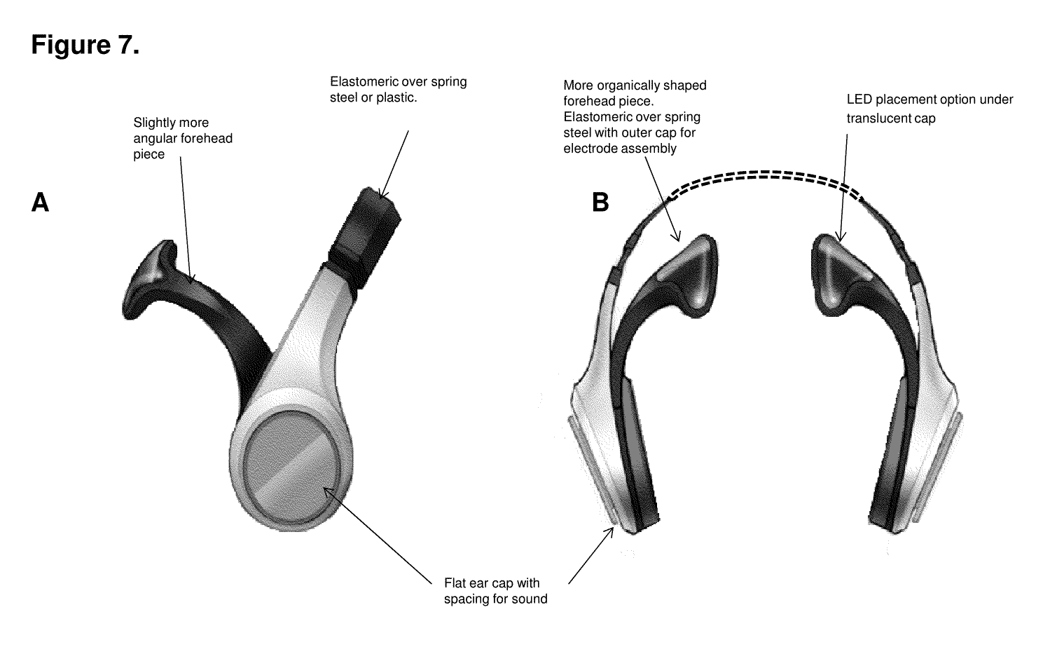

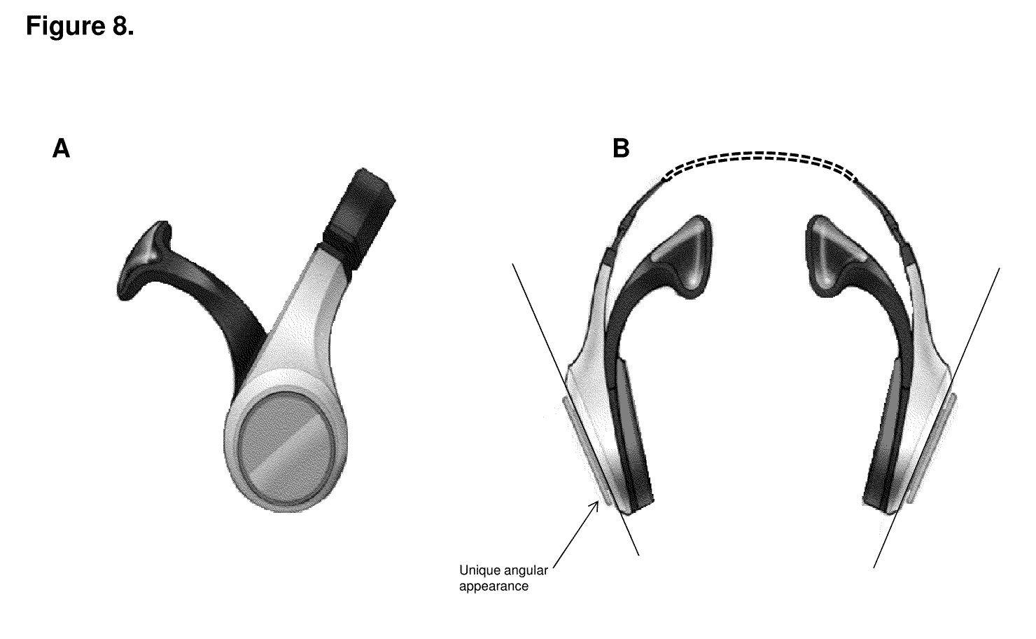

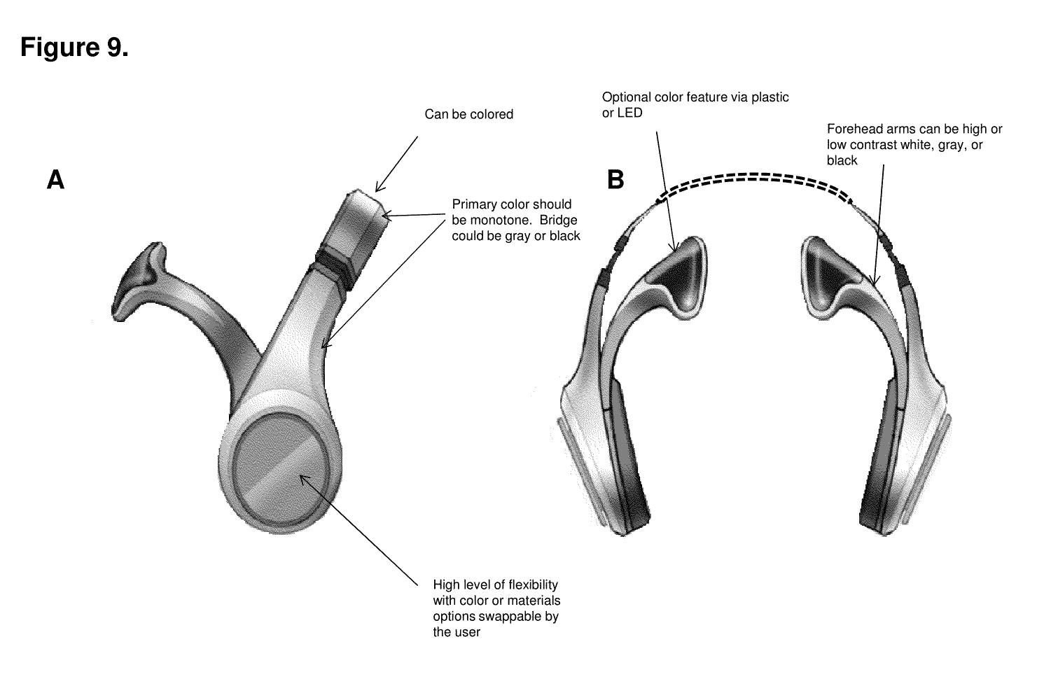

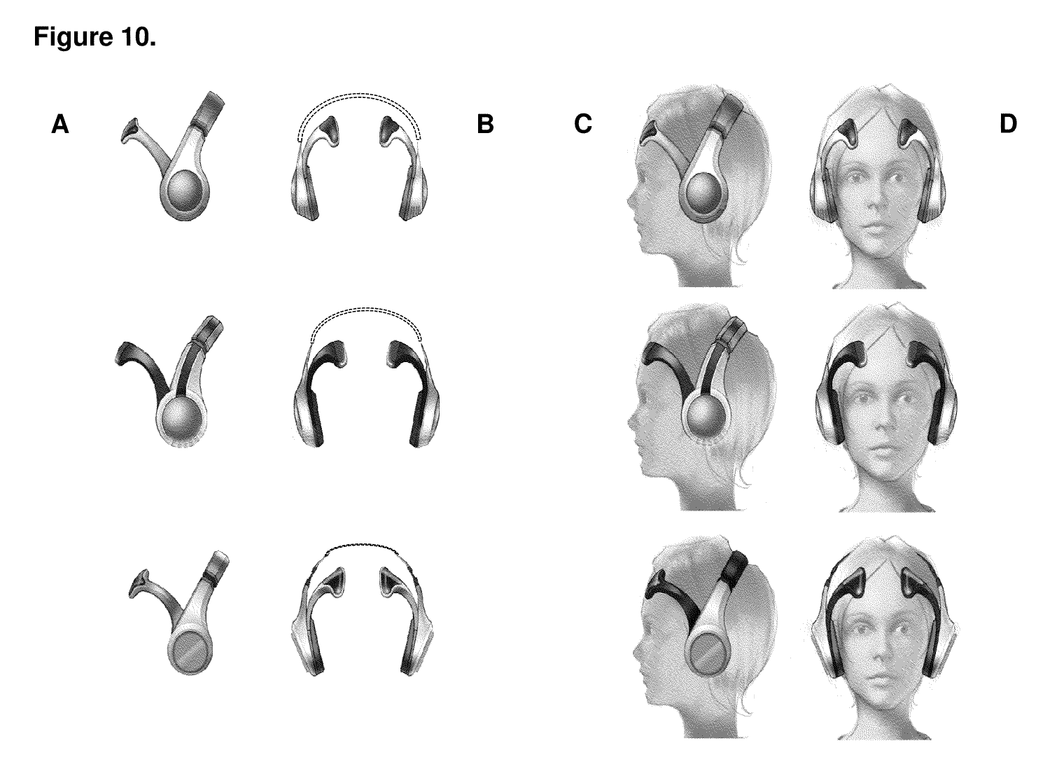

There is an option for LEDs under the arm caps. The head bridge is also of coordinating elastomeric materials over spring steel. FIG. 6 demonstrates the vertical appearance of an embodiment with earpieces that are wider at the bottom of the ear than they are at the top. FIG. 7 depicts an embodiment with flat colored ear caps and an arm with a rounded terminal end. The arms are more angular in appearance and their terminal ends each have a translucent cap that can have an LED underneath. The head bridge is elastomeric over spring steel or plastic. FIG. 8 depicts the unique angular appearance that results when the earpieces are tapered (i.e., when the top of the earpiece is wider than the bottom). FIG. 9 depicts another embodiment where the head bridge background color can be gray or black with a narrow colored band going over the head. This embodiment includes the possibility of the user changing the color of the earpieces. There is another optional color feature via the plastic or LED ends of the arms which can be high or low contrast white, gray, or black. FIG. 10 compares several embodiments of the headset side by side and includes images of those embodiments as worn by a user.

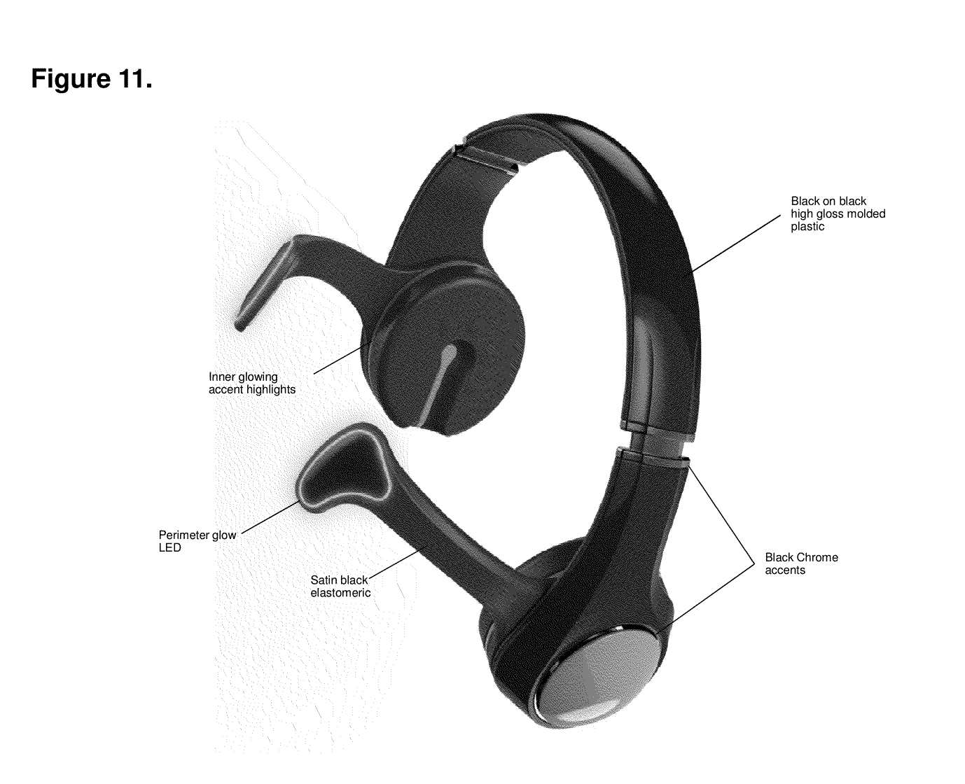

FIG. 11 depicts an embodiment of the headset with a black on black high gloss molded plastic head bridge which comprises a hollow head bridge having at least one guide track formed therein and including at least one elongated piece that can slide in the guide track for adjustment through a range of positions between fully extended and retracted positions relative to the earpieces allowing adjustment of the size of the headset. The earpieces also have black chrome accents and each have an integrated pivoting arm between the outer plastic ear cap and the inner ear cushion with LEDs on the terminal end. Glowing accent highlights are also present between the pivoting arm and the ear cushion.

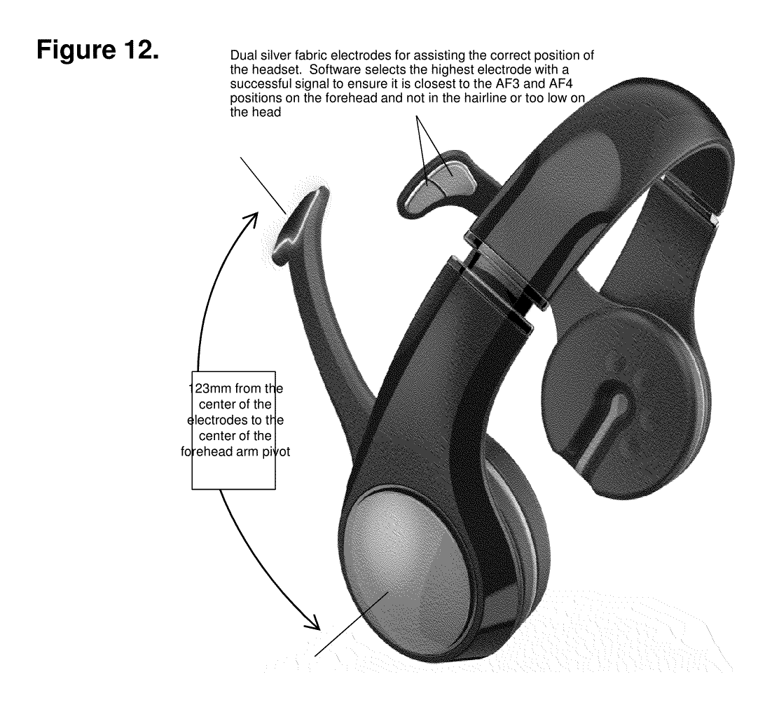

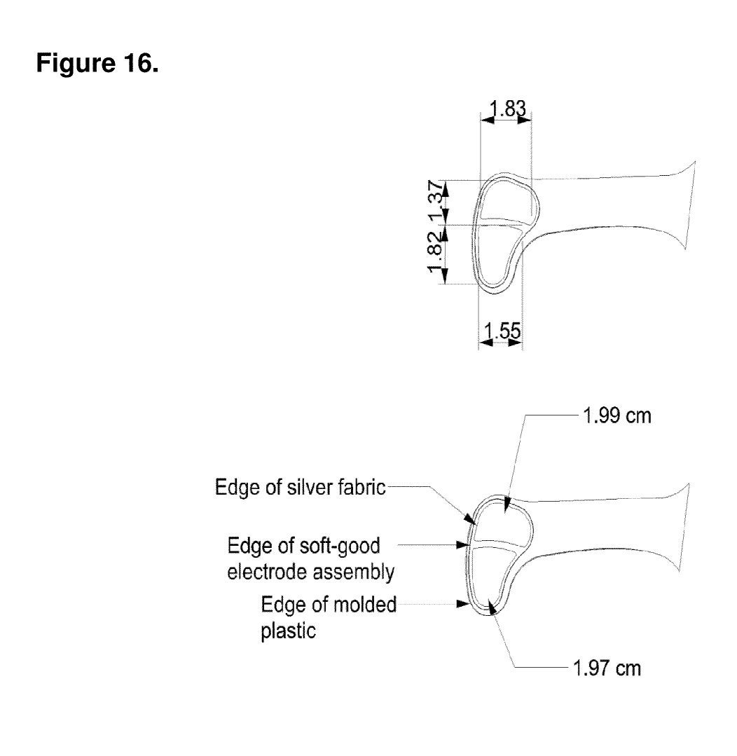

FIG. 12 is a further drawing of FIG. 11 demonstrating that the distance between from the center of the ear piece to the center of the electrical sensor is 123 mm. The dual silver fabric electrodes are visible on the inner surface of one of the pivoting arms. FIG. 16 is a possible example of the two sensors visible in FIG. 12. The edge of the silver fabric rests just inside the edges of the electrode assembly which is just inside the edges of the molded plastic.

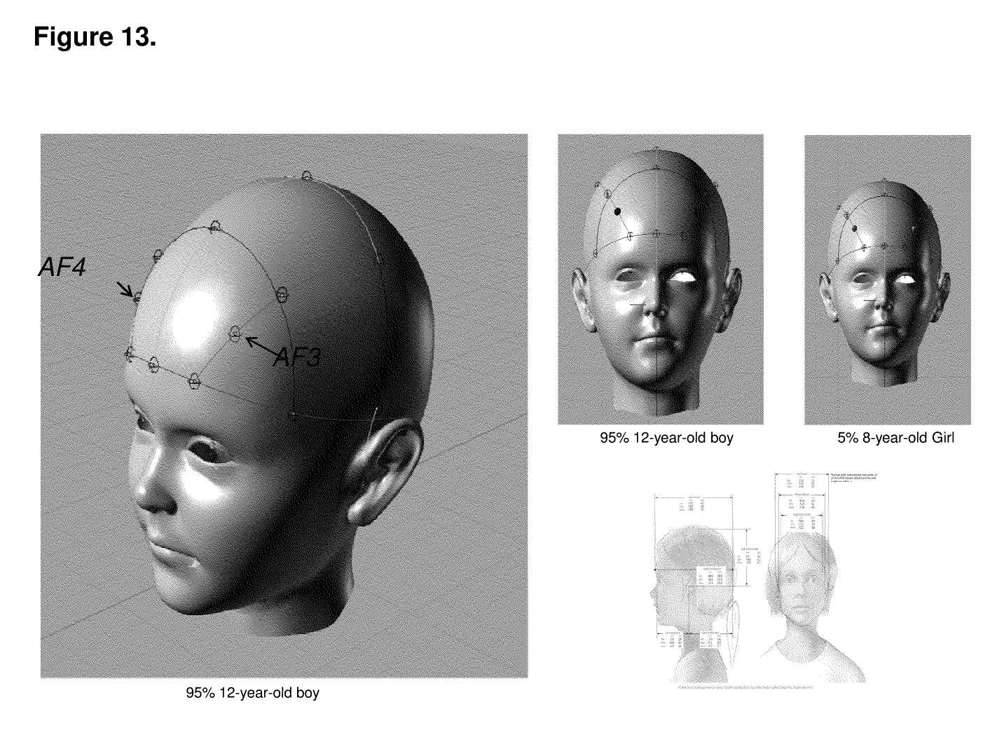

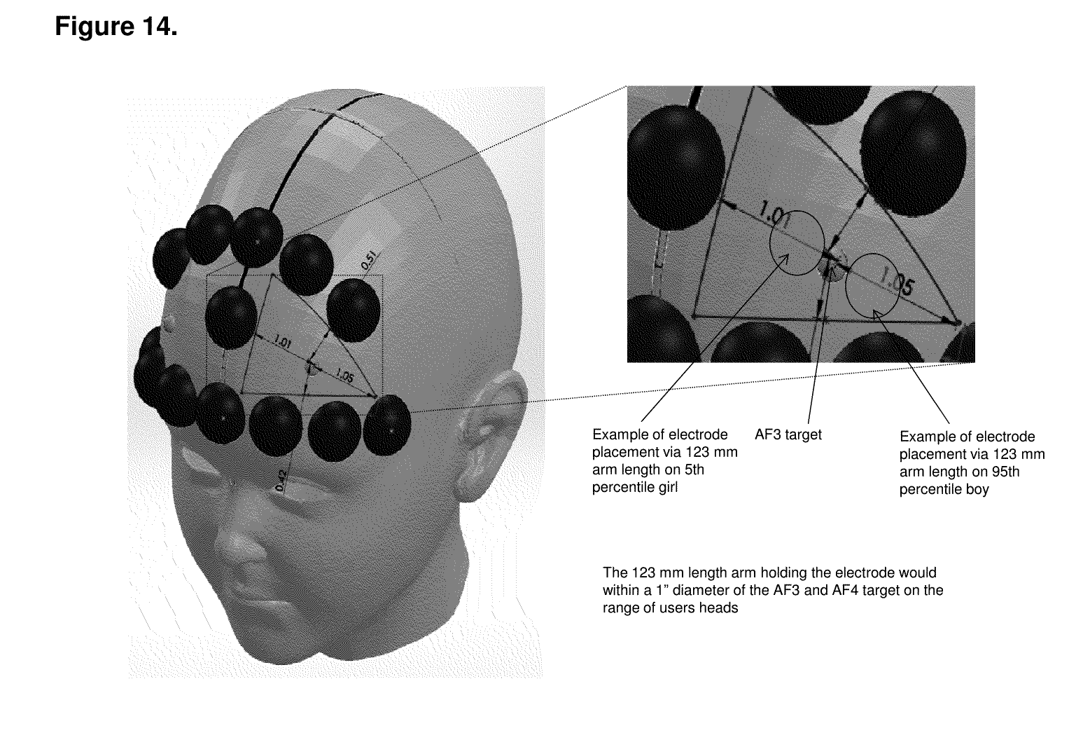

FIGS. 13 and 14 demonstrate the proper placement of the electrical sensors on the forehead of a child mannequin. FIG. 14 shows the calculated distances for an 8-year-old girl of size in the 5^{th} percentile and a 12-year-old boy of size in the 95^{th} percentile when the arm is sized as depicted in FIG. 12.

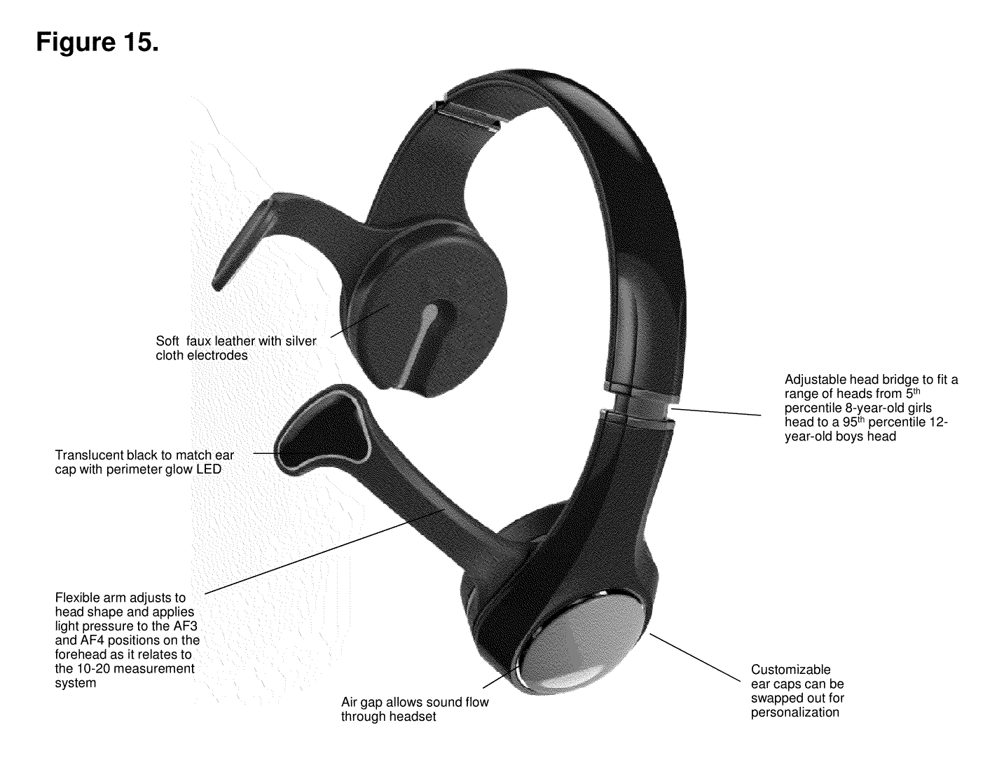

FIG. 15 describes an embodiment of the headset. The earpieces have customizable ear caps that can be personalized by the user and a translucent black terminal end of the arms each with a perimeter glow LED. The earpieces also have an air gap that allows sound to flow through the earpiece to the user. The flexible arms adjust to head shape and apply light pressure to either the AF3 or AF4 positions on the forehead. This embodiment also demonstrates the earpiece electrical sensors which can be in the faux leather ear cushions. One of these sensors can either provide a ground for the other electrical sensors on the arms, or act as an additional electrical sensor. The locations of the electrical sensors in the ear cushions provide more comfort to the user as compared to ear clips present in some alternate EEG headsets.

One embodiment of the headset includes an accelerometer. The inclusion of the accelerometer will allow for the translation of head movements into video game application mechanics and movements (e.g., the user can cause a game avatar to jump by moving the user's head upward). An accelerometer could also serve as a quantifier for activity in the user and potentially be useful as a diagnostic for activity disorders.

Another embodiment includes a locator. This could be radio frequency identification, global positioning system, or other microchip to enable the finding of the headset. This locating feature provides a means for locating a headset misplaced by the user.

LED elements present in the headset can be lit in response to the attention state of the user or, when part of a gaming system, in response to events occurring in the game and/or the user's game performance.

### Other Embodiments

All publications, patents, and patent applications mentioned in this specification are herein incorporated by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

1. A headset comprising:
two earpieces connected by a head bridge; each of said earpieces connected to an arm having a proximate end connected to one of the two ear pieces and a terminal end comprising an electrical sensor, wherein each arm is configured to permit the electrical sensor to contact the forehead of a user at positions AF3 or AF4.

2. The headset of claim 1, wherein the electrical sensor comprises one electrode.

3. The headset of claim 1, wherein the electrical sensor comprises two electrodes.

4. The headset of claim 1, wherein the arm has a shape comprising an arc.

5. The headset of claim 1, wherein the distance from the center of the ear piece to the center of the electrical sensor is 123+10 mm.

6. The headset of claim 1, wherein the electrical sensor comprises a fabric electrode.

7. The headset of claim 1, wherein one of the two ear pieces comprises an electrical sensor positioned to contact the ear lobe of a user.

8. The headset of claim 1, wherein one of the two ear pieces comprises a ground electrode configured to contact the ear of a user.

9. The headset of claim 1, wherein the arm comprises a flexible member, wherein when the headset is worn by a user, the flexible member is configured to apply light pressure of the electrical sensor to the forehead of the user.

10. The headset of claim 9, wherein each arm comprises an elastomeric material and/or a spring.

11. The headset of claim 1, wherein the head bridge comprises an elastomeric material.

12. The headset of claim 1, wherein the head bridge is adjustable to accommodate various head sizes.

13. The headset of claim 1, wherein the headset is sized and configured to accommodate a range of head sizes from the 5^{th} percentile of 8 year old girls to the 95^{th} percentile of 12 year old boys.

14. The headset of claim 1, wherein the headset has an expanded configuration for placement on the head of a user, the expanded configuration having a fixed predetermined angle between the head bridge and each arm.

15. The headset of claim 14, wherein the angle between the head bridge and each arm is collapsible to permit the headset to fold from the expanded configuration to a contracted configuration for storage.

16. The headset of claim 1, wherein the headset further comprises an accelerometer, a locator, and/or LED lights placed around one or more of the ear pieces, each electrical sensor, and/or each arm.

17. The headset of claim 1, wherein the earpieces comprise one or more openings to permit the passage of external sounds to the ear of a user; or wherein the earpieces comprise a speaker.

18. An electrode system comprising:
(a) a first electrical sensor configured to contact the forehead of a user at position AF3, the first electrical sensor comprising two or more electrodes, and a second electrical sensor configured to contact the forehead of a user at position AF4, the second electrical sensor comprising two or more electrodes; and
(b) a processor equipped with an algorithm for selecting, independently, at the first electrical sensor and the second electrical sensor from among the two or more electrodes (i) the electrode positioned highest on the forehead of a user capable of making a connection with one of positions AF3 or AF4; (ii) the electrode providing the best signal quality; or (iii) the electrode providing the best contact.

19. A system comprising:
(a) a headset comprising two earpieces connected by a head bridge; each of said earpieces connected to an arm having a proximate end connected to one of the two ear pieces and a terminal end comprising an electrical sensor, wherein each arm is configured to permit the electrical sensor to contact the forehead of a user at positions AF3 or AF4 and wherein the electrical sensor comprises two or more electrodes; and
(b) a processor equipped with an algorithm for selecting, independently, at each arm from among the two or more electrodes (i) the electrode positioned highest on the forehead of a user capable of making a connection with one of positions AF3 or AF4; (ii) the electrode providing the best signal quality; or (iii) the electrode providing the best contact.

20. A system comprising:
(i) a headset comprising two earpieces connected by a head bridge; each of said earpieces connected to an arm having a proximate end connected to one of the two ear pieces and a terminal end comprising an electrical sensor, wherein each arm is configured to permit the electrical sensor to contact the forehead of a user at positions AF3 or AF4 to collect EEG signals; and
(ii) a processor equipped with an algorithm for analyzing the EEG signals to determine the attention level of the subject,
wherein the headset and the processor are in wireless communication.
